(19) United States
(12) Patent Application Publication
(10) Pub. No.: US 2026/0113564 A1
(43) Pub. Date: Apr. 23, 2026

(54) HEADSET WITH A DAMPING MECHANISM

(71) Applicant: Luxshare Precision Industry Company Limited, SHENZHEN (CN)

(72) Inventor: Wei YANG, SHENZHEN (CN)

(73) Assignee: Luxshare Precision Industry Company Limited, SHENZHEN (CN)

(21) Appl. No.: 19/097,159

(22) Filed: Apr. 1, 2025

(30) Foreign Application Priority Data
Oct. 22, 2024 (CN) 202411485339.5

(51) Int. Cl. H04R 1/10

(52) U.S. Cl. CPC H04R 1/105; H04R 1/1008

(57) ABSTRACT

Provided is a headset including a damping mechanism, which relates to the technical field of earphones. The damping mechanism for the headset includes a housing, a sliding arm, a sliding member, and a damping member. At least part of the housing is arc-shaped. The sliding arm is arc-shaped and disposed in the housing, and the sliding arm has an elongated first damping portion. The sliding member is slidably connected to the housing. The damping member is connected to the sliding member and is capable of moving relative to the sliding member. The damping member has a second damping portion capable of being press-fitted with the first damping portion to generate frictional forces between the second damping portions and the first damping portions during reciprocating movement of the sliding member relative to the housing.

### CROSS-REFERENCE TO RELATED APPLICATION

This application claims priority to Chinese patent application No. 202411485339.5 filed with the China National Intellectual Property Administration (CNIPA) on Oct. 22, 2024, the disclosure of which is incorporated herein by reference in its entirety.

### TECHNICAL FIELD

The present disclosure relates to the technical field of earphones and, in particular, to a headset with a damping mechanism.

### BACKGROUND

Headsets have advantages such as an excellent sound field, superior sound quality, great comfort, the prevention of ear canal abrasion, and the protection of eardrums. Therefore, headsets are highly favored by users. A headset mainly includes a headband, earphone housings, and other components. During use, the headband is located on a user's head, the earphone housings are located on the outsides of two ears. To adapt to the head shapes of different users, the length of the headband needs to be adjustable. The headband generally includes a housing and sliding members that slide relative to the housing. The earphone housings are connected to the sliding members.

During adjustment, to ensure a damping feel during the slide of each of the sliding members, a damping mechanism is generally disposed between each of the sliding members and the housing. There are mainly the following two types of damping mechanisms at present. For one type of damping mechanism, an elastic sheet on the sliding member is fitted with an engagement slot of the housing. In this structure, the elastic sheet needs to have a certain dimension to provide a sufficient elastic force. Therefore, a large housing space is required. Additionally, the elastic sheet is generally made of metal, and noises are easily generated by the friction between the elastic sheet and the housing. For the other type of damping mechanism, a soft component such as a silica gel is disposed on the sliding member to directly generate friction with the housing made of hard plastic or metal so that damping is generated. However, the amount of deformation of the soft component is difficult to control. As a result, a damping feel is unstable and user experience is affected.

Therefore, a damping mechanism for a headset needs to be researched to solve the preceding problems.

### SUMMARY

The present disclosure provides a headset including a damping mechanism. The damping mechanism includes a housing, a sliding arm, a sliding member, and a damping member. At least part of the housing is arc-shaped. The sliding arm is arc-shaped and disposed in the housing, and the sliding arm has elongated first damping portions. The sliding member is slidably connected to the housing. The damping member is connected to the sliding member and is capable of moving relative to the sliding member, the damping member has second damping portions capable of being press-fitted with the first damping portions to generate frictional forces between the second damping portions and the first damping portions during reciprocating movement of the sliding member relative to the housing.

In some embodiments, the sliding arm includes a sliding groove, the sliding member includes an external sliding connection portion and a sliding-fit portion, the sliding-fit portion is arc-shaped and has a radian that is consistent with the radian of the sliding arm, and the sliding-fit portion is disposed in the sliding groove and is fixedly connected to the damping member.

In some embodiments, two opposite sidewalls at an opening of the sliding groove protrude towards each other to form necking portions, parts of the top surfaces of the necking portions form the first damping portions, the damping member includes a mounting portion and a friction portion that are connected to each other, the mounting portion is mounted on the upper side of the sliding member and partially extends out of the sliding groove, the friction portion is located on the outer side of the sliding groove and the extension direction of the friction portion is perpendicular to the extension direction of the sliding groove, the length of the friction portion is greater than the width of the sliding groove, the bottom surface of the friction portion form the two second damping portions, the two second damping portions are pressed against the first damping portions, and the sliding member is abutted against the bottom surface of the necking portion.

In some embodiments, two sliding protrusions that are strip-shaped and extend in a direction parallel to the extension direction of the sliding groove are provided on the top of the sliding arm, the two sliding protrusions are respectively provided on two sides of the sliding groove, the damping member includes two sliding slots, and the two sliding slots correspond to and are in a sliding fit with the two sliding protrusions.

In some embodiments, a first limit portion and a second limit portion are spaced apart on the sliding arm, where the sliding member is stopped by the damping member and is abutted against the first limit portion in a process where the sliding member slides along the sliding arm, or the sliding member is stopped by the damping member and is abutted against the second limit portion in the process where the sliding member slides along the sliding arm.

In some embodiments, the sliding arm includes a sliding body and a stop member, where the sliding body includes a sliding groove and a stop ring that is provided at an end portion of the sliding groove, the stop ring forms the first damping portion, the outer diameter of the sliding member is greater than the inner diameter of the stop ring and the sliding member is capable of being abutted against the stop ring, the stop member is connected to the sliding body, and part of the stop member forms the second limit portion.

In some embodiments, the sliding member is disposed in the sliding groove, the stop member has a cylindrical structure and is sleeved on an end of the sliding body, an integrally formed stop plate is provided at an end portion of the stop member, at least part of the stop plate is located in the sliding groove, the stop plate is the second limit portion, and a buffer portion protrudes on a side of the damping member facing the second limit portion for being abutted against the second limit portion.

In some embodiments, a strip-shaped stop portion extending towards the inside of the stop member is formed on a sidewall of the stop member through blanking, and the outer sidewall of the sliding body is provided with a stop slot and a stop protrusion, the stop slot and the stop protrusion are spaced apart along the extension direction of the sliding groove, the stop portion is insertable into the stop slot and is capable of being abutted against a sidewall of the stop slot facing away from the stop protrusion, and the stop member is abutted against the stop protrusion.

In some embodiments, the damping mechanism further includes a fixedly connected member, where one end of the fixedly connected member is fixedly connected to the sliding member and the other end of the fixedly connected member is fixedly connected to the damping member.

In some embodiments, a fixedly connected channel is provided at an end of the fixedly connected member, and the sliding member is inserted through the fixedly connected channel and is connected to the fixedly connected member by at least one of screwing or bonding.

In some embodiments, the sliding arm includes a sliding groove, the sliding member has a circular cross section and is slidably disposed in the sliding groove, a sliding bump is provided at the lower end of the fixedly connected member, a sliding rail is recessed from the inner wall of the sliding groove, and the sliding bump is slidably disposed in the sliding rail along the sliding direction of the sliding member; and/or a first anti-rotation plane is provided at the position where the fixedly connected member is sleeved on and fitted with the sliding member, a second anti-rotation plane is provided on the inner wall of the fixedly connected channel, and the first anti-rotation plane and the second anti-rotation plane are parallel to and fit snugly with each other.

In some embodiments, a fixing rod protrudes at the other end of the fixedly connected member, the damping member is provided with a mounting hole, the fixing rod is inserted through the mounting hole, and an end portion of the fixing rod is provided with an engagement groove, and a circlip is engaged in the engagement groove to be pressed against the damping member.

In some embodiments, one of the fixedly connected member and the damping member includes a positioning slot and the other one of the fixedly connected member and the damping member includes a positioning protrusion, the positioning protrusion and the fixing rod are spaced apart along the sliding direction of the sliding member, and in response to the fixing rod being inserted through the mounting hole, the positioning protrusion is inserted into the positioning slot.

In some embodiments, the housing has an accommodation cavity and a sliding channel communicating with the accommodation cavity, the damping mechanism further includes a guide assembly having a guide slideway, the guide assembly is disposed in the sliding channel, the sliding member is inserted through the guide slideway and is slidable relative to the guide assembly under a guide action of the guide slideway, and at least part of the sliding member connected to the damping member is located in the accommodation cavity.

In some embodiments, the guide slideway is arc-shaped, the sliding member includes a sliding-fit portion and an external sliding connection portion that are connected to each other, the sliding-fit portion is slidably disposed in the guide slideway and is arc-shaped, and the sliding-fit portion and the sliding channel have the same radian.

In some embodiments, the guide assembly includes a guide member with a cylindrical structure and a connector, the guide slideway is provided in the guide member, and the connector is arranged to be capable of detachably connecting the guide member to the housing.

In some embodiments, the guide member is partially inserted in the sliding channel, the guide member includes a first engagement slot, the housing includes a second engagement slot, in response to the guide member being mounted in the sliding channel, the first engagement slot and the second engagement slot enclose an engagement channel, the extension direction of the engagement channel is perpendicular to the extension direction of the sliding channel, and the connector includes a columnar engagement portion and is insertable into the engagement channel.

In some embodiments, the guide member includes two first engagement slots, the housing includes two second engagement slots corresponding to the two first engagement slots to form two engagement channels, the two engagement channels are respectively provided on two sides of the axis of the guide member one to one, the connector includes two engagement portions provided in parallel, and the two engagement portions are correspondingly insertable into the two engagement channels.

In some embodiments, the material of the sliding arm and the material of the damping member are each polyoxymethylene, and the material of the sliding arm and the material of the housing are different from each other.

### BRIEF DESCRIPTION OF DRAWINGS

FIG. 1 is a structural view of a damping mechanism for a headset from a first perspective in an embodiment of the present disclosure;

FIG. 2 is a structural view of a damping mechanism for a headset from a second perspective in an embodiment of the present disclosure;

FIG. 3 is a cross-sectional view taken along A-A in FIG. 2;

FIG. 4 is a structural view showing that a sliding member passes through a fixedly connected member to be connected to a damping member in an embodiment of the present disclosure;

FIG. 5 is a structural view of a fixedly connected member in an embodiment of the present disclosure;

FIG. 6 is a structural view of a damping mechanism for a headset from a third perspective in an embodiment of the present disclosure;

FIG. 7 is an enlarged view of part B in FIG. 6;

FIG. 8 is a structural view showing that a sliding body is connected to a stop member in an embodiment of the present disclosure;

FIG. 9 is a structural view of a sliding arm in an embodiment of the present disclosure; and

FIG. 10 is a structural view of a housing in an embodiment of the present disclosure.

### REFERENCE LIST

100 housing
110 second engagement slot
120 insertion slot
130 fixing column
131 fixing screw hole
132 fastener
200 sliding arm
210 sliding body
211 first damping portion
212 sliding groove
213 necking portion
214 sliding protrusion
215 first limit portion
216 stop slot
217 stop protrusion
218 sliding rail
2191 insertion protrusion
2192 fixing hole
220 stop member
221 second limit portion
222 stop portion
230 fixedly connected member
231 fixedly connected channel
232 fixing boss
233 sliding bump
2331 accommodation slot
234 second anti-rotation plane
235 fixing rod
236 engagement groove
237 limit surface
238 positioning slot
240 circlip
300 sliding member
310 external sliding connection portion
320 sliding-fit portion
321 first anti-rotation plane
322 dispensing hole
400 damping member
410 mounting portion
420 friction portion
421 second damping portion
422 sliding slot
423 horizontal damping portion
424 vertical damping portion
430 buffer block
500 guide assembly
510 guide member
511 guide slideway
512 first engagement slot
520 connector
521 engagement portion
522 connection rod

### DETAILED DESCRIPTION

The technical solutions of the present disclosure are described clearly and completely below in conjunction with the drawings. Apparently, the described embodiments are part, not all, of embodiments of the present disclosure. Based on the embodiments of the present disclosure, all other embodiments obtained by those of ordinary skill in the art without creative work are within the scope of the present disclosure.

In the description of the present disclosure, it is to be noted that orientations or position relations indicated by terms such as “center”, “upper”, “lower”, “left”, “right”, “vertical”, “horizontal”, “in”, and “out” are based on the drawings. These orientations or position relations are intended only to facilitate and simplify the description of the present disclosure and not to indicate or imply that a device or element referred to must have such particular orientations or must be configured or operated in such particular orientations. Thus, these orientations or position relations are not to be construed as limiting the present disclosure. In addition, terms such as “first” and “second” are used only for the purpose of description and are not to be construed as indicating or implying relative importance. The terms “first position” and “second position” are two different positions. Moreover, when a first feature is described as “on”, “above”, or “over” a second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of the present disclosure, it is to be noted that unless otherwise expressly specified and limited, the term “mounted”, “connected to each other”, or “connected” should be construed in a broad sense, for example, as securely connected, detachably connected, or integrally connected; mechanically connected or electrically connected; directly connected to each other or indirectly connected to each other via an intermediary; or interconnected between two elements. For those of ordinary skill in the art, specific meanings of the preceding terms in the present disclosure may be understood based on specific situations.

An object of the present disclosure is to provide a headset including a damping mechanism to solve the problem that a large housing space is required, resulting in a relatively large dimension of a headset, inconvenient use of the headset, and easy generation of noises between an elastic sheet and an engagement slot of the headset or the problem that the amount of deformation of a soft material is difficult to control, resulting in an unstable damping feel in the related art.

The embodiments of the present disclosure are described below in detail. Examples of the embodiments are illustrated in the drawings, where the same or similar reference numerals throughout the drawings represent the same or similar elements or elements having the same or similar functions. The embodiments described below with reference to the drawings are illustrative and intended only to explain the present disclosure and cannot be construed as limiting the present disclosure.

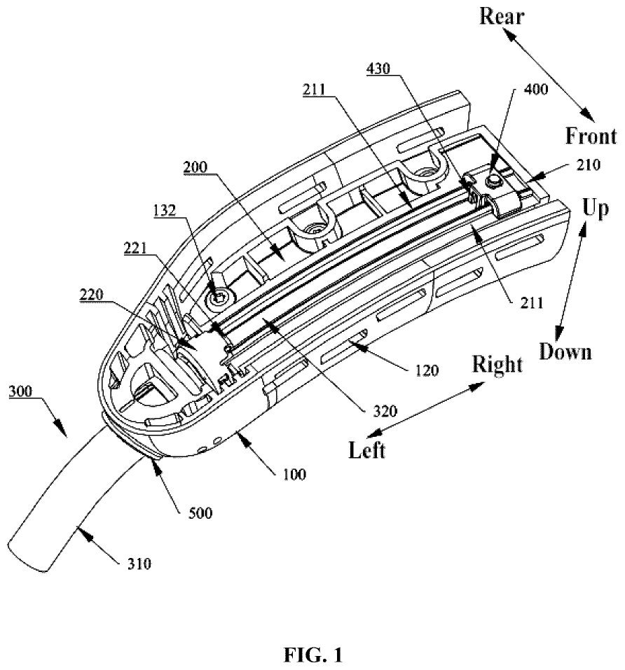

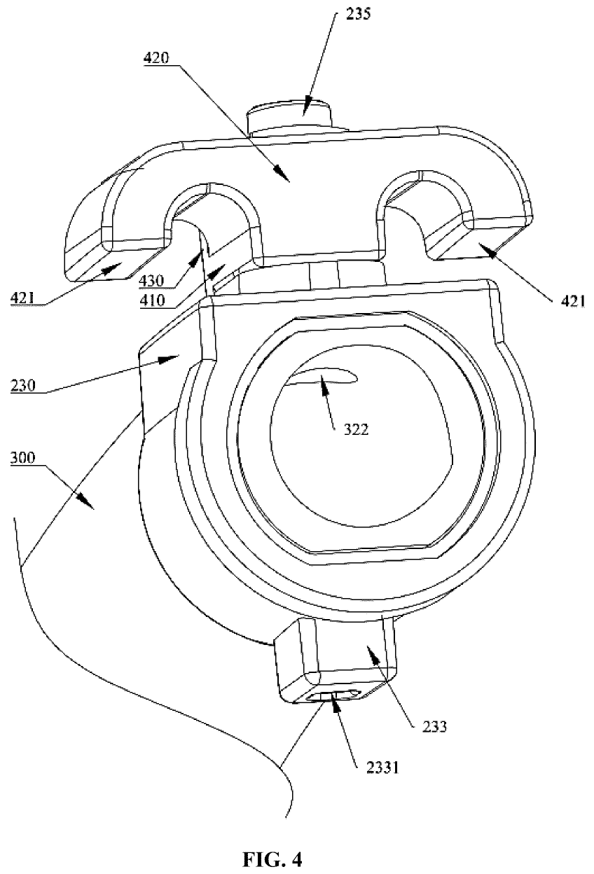

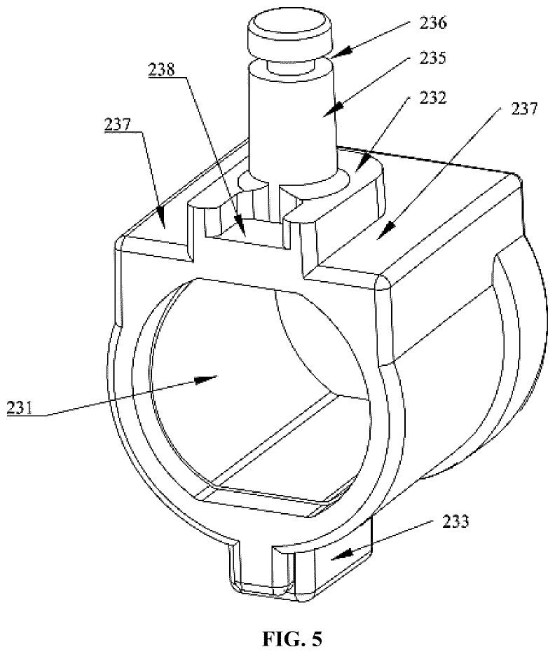

As shown in FIGS. 1 to 10, a damping mechanism for a headset is provided in the embodiment of the present disclosure, so that the dimension of the entire mechanism is reduced and the possibility of noises is reduced. The damping mechanism includes a housing 100, a sliding arm 200, a sliding member 300, and a damping member 400. At least part of the housing 100 is arc-shaped so that when used on the headset, the housing 100 is adaptable to the shape of a user's head. The sliding arm 200 is arc-shaped and disposed in the housing 100. The sliding arm 200 has elongated first damping portions 211. The sliding member 100 is movably restricted in the housing 100. The damping member 400 is connected to the sliding member 300 and is capable of moving relative to the sliding member 300. For example, the damping member 400 is capable of moving relative to the sliding member 300. The damping member 400 has second damping portions 421 capable of being press-fitted with the first damping portions 211 to generate frictional forces between the second damping portions 421 and the first damping portions 211 during reciprocating movement of the sliding member 300 relative to the housing 100. The material of the sliding arm 200 and the material of the damping member 400 are each polyoxymethylene (POM). In addition, the material of the sliding arm 200 and the material of the housing 100 are different from each other.

The first damping portion 211 and the second damping portion 421 each have an arc-shaped surface. The radian of the first damping portion 211 and the radian of the second damping portion 421 are each the same as the radian of the sliding arm 200 along the extension direction of the sliding arm 200 so that the surface contact therebetween is implemented.

Since the material of the sliding arm 200 and the material of the damping member 400 are each the POM, a damping feeling is generated in a sliding process as long as the sliding arm 200 and the damping member 400 are pressed tightly. Compared with an elastic sheet, it is unnecessary to provide an excessively large space, thereby facilitating the reduction of the dimension of the damping mechanism. Moreover, since the material properties of the POM include a self-lubricating property, the possibility of noises in a friction process is reduced. In addition, the POM has relatively high hardness and better wear resistance and is not easy to deform so that it is easier to ensure the stability of the damping feel.

To further reduce the dimension, in some embodiments, the sliding arm 200 includes a sliding groove 212, and the sliding member 300 includes an external sliding connection portion 310 and a sliding-fit portion 320. The sliding-fit portion 320 is arc-shaped and has a radian that is consistent with the radian of the sliding arm 200. The sliding-fit portion 320 is disposed in the sliding groove 212 and is fixedly connected to the damping member 400. The external sliding connection portion 310 is used for connecting an earphone housing. To increase the strength of the entire damping mechanism, the outer diameter of the cross-sectional contour of the sliding arm 200 is appropriately increased. However, to reduce the dimension of the damping mechanism, the sliding groove 212 is provided on the sliding arm 200, and the sliding-fit portion 320 is disposed in the sliding groove 212. Thus, the sliding member 300 partially overlaps the sliding arm 200 in an extension direction perpendicular to the damping mechanism so that the cross-sectional area of the damping mechanism is reduced, thereby reducing the volume of the damping mechanism.

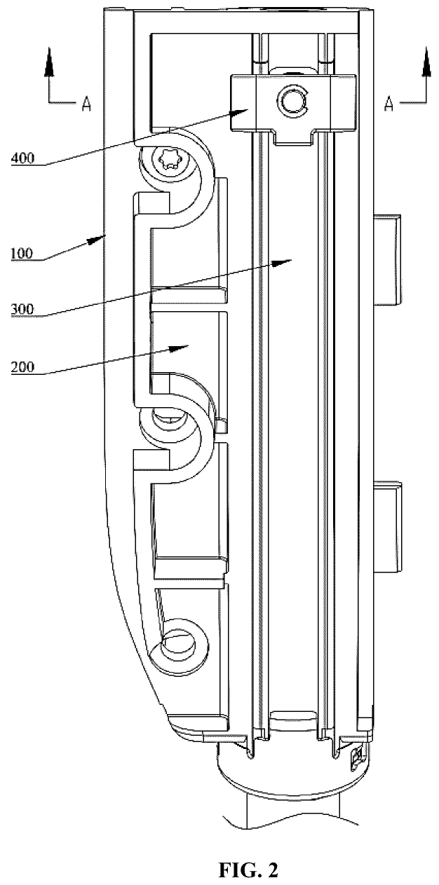

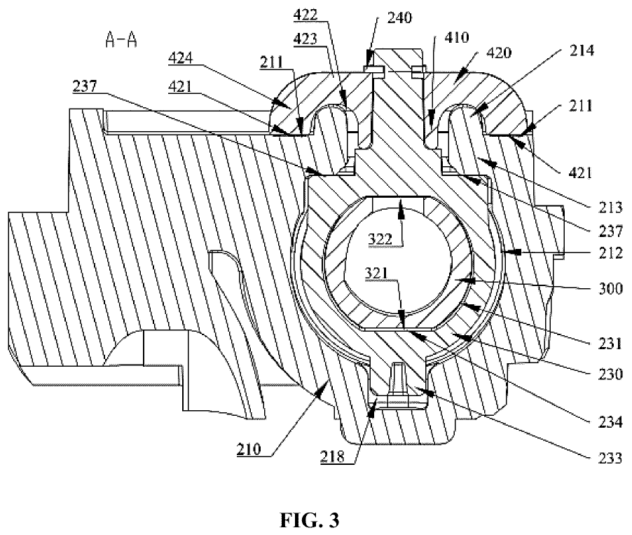

In conjunction with FIGS. 2 and 3, to ensure balanced damping and prevent the sliding member 300 from shifting in the sliding process, in some embodiments, two opposite sidewalls at an opening of the sliding groove 212 protrude towards each other to form necking portions 213. Parts of the top surfaces of the necking portions 213 form the first damping portions 211. The damping member 400 includes a mounting portion 410 and a friction portion 420 that are connected to each other. The mounting portion 410 is mounted on the upper side of the sliding member 300 and partially extends out of the sliding groove 212. The friction portion 420 is located on the outer side of the sliding groove 212 and the extension direction of the friction portion 420 is perpendicular to the extension direction of the sliding groove 212. The length of the friction portion 420 is greater than the width of the sliding groove 212. The bottom surface of the friction portion 420 forms the two second damping portions 421. The two second damping portions 421 are pressed against the first damping portions 211. The sliding member 300 is abutted against the bottom surface of the necking portion 213. The contact between each of the two first damping portions 211 and a respective one of the two second damping portions 421 results in a more stable structure and a more balanced frictional force between the sliding member 300 and the sliding arm 200 and convenient control over the sliding member 300 and the sliding arm 200. In addition, an increased contact area further reduces a wear rate, and it is easier to maintain a constant magnitude of the frictional force between the sliding member 300 and the sliding arm 200. That is, it is easier to maintain the same damping feel, thereby improving user experience.

In some embodiments, a sliding protrusion 214 is provided on one of the top surface of the sliding arm 200 and the bottom surface of the damping mechanism 400, and a sliding slot 422 is provided on the other one of the top surface of the sliding arm 200 and the bottom surface of the damping mechanism 400. The sliding protrusion 214 is slidably configured in the sliding slot 422. Two sliding protrusions 214 that are strip-shaped and extend in a direction parallel to the extension direction of the sliding groove 212 are provided on the top of the sliding arm 200. The two sliding protrusions 214 are respectively provided on two sides of the sliding groove 212. The damping member 400 includes two sliding slots 422, and the two sliding slots 422 correspond to and are in a sliding fit with the two sliding protrusions 214. The sliding slots 422 are provided so that the friction portion 420 of the damping member 400 forms a cantilever structure, that is, the friction portion 420 includes vertical damping portions 424 and a horizontal damping portion 423 that are connected to each other. The horizontal damping portion 423 is used as the cantilever structure and is able to provide certain elasticity for the vertical damping portions 424. The bottom end of each of the damping vertical portions 424 forms a respective first damping portion 211. Thus, each of the first damping portions 211 has a larger elastic change space, thereby ensuring a damping effect and prolonging a service life.

The sliding protrusions 214 are provided at the top of the necking portions 213. With this configuration, the structural strength of the necking portions 213 can be improved and the capability of the necking portions 213 to resist deformation can be improved, which is conducive to ensuring the stability of the damping feel.

In other embodiments, the inner wall of each of the sliding slots 422 is press-fitted with a sidewall of a respective one of the sliding protrusions 214 to generate a frictional force. In the extension direction of the sliding arm 200, the damping effect can be improved as much as possible on the premise that the damping member 400 has a limited length. Thus, the material used for the damping member 400 is reduced, thereby reducing the cost. In an example, the two opposite inner sidewalls of the two sliding slots 422 that are relatively far from each other are abutted against the two sidewalls of the two sliding protrusions 214 facing away from each other. In other words, the front sidewall of the front sliding slot 422 is abutted against the front sidewall of the front sliding protrusion 214, and the rear sidewall of the rear sliding slot 422 is abutted against the rear sidewall of the rear sliding protrusion 214. With this configuration, damping is generated between the damping member 400 and the sliding arm 200, and the upper opening of the sliding groove 212 is caused to have a narrowing tendency. In addition, the cross section of the sliding arm 200 perpendicular to the extension direction of the sliding arm 200 is generally U-shaped and is in the shape of a bow. Thus, the entire sliding arm 200 maintains tension to maintain the stability of friction damping.

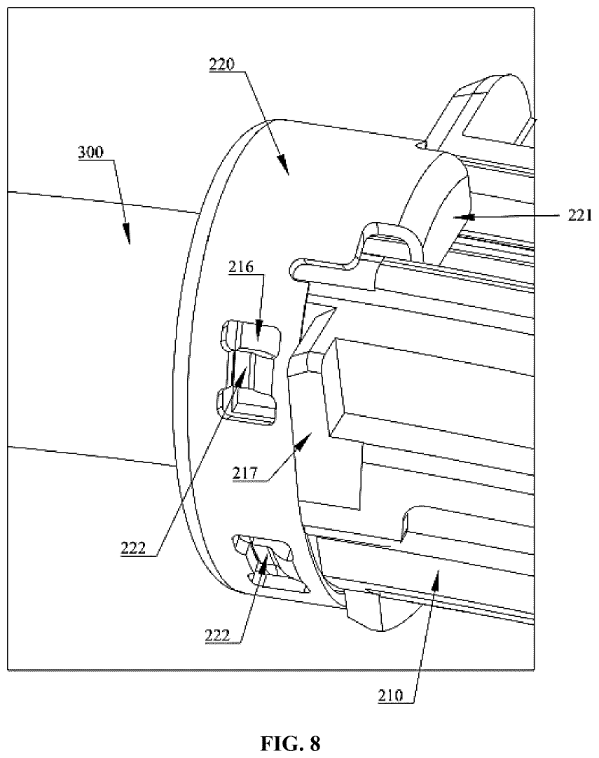

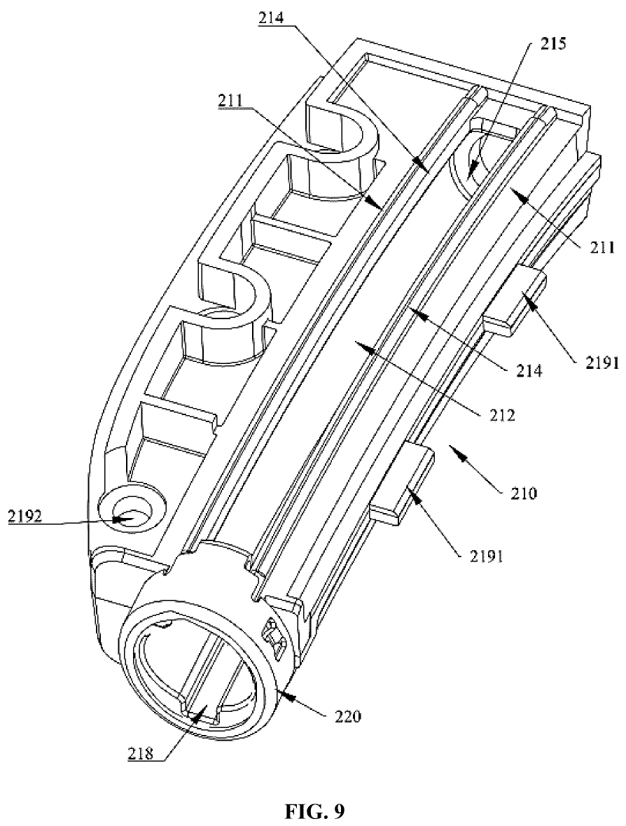

In conjunction with FIGS. 8 and 9, a first limit portion 215 and a second limit portion 221 are spaced apart on the sliding arm 200. The sliding member 300 is stopped by the damping member 400 and is abutted against the first limit portion 215 in a process where the sliding member 400 slides along the sliding arm 200, or the sliding member 300 is stopped by the sliding member 300 and is abutted against the second limit portion 221 in the process where the sliding member 300 slides along the sliding arm 200. The housing 100 is made of plastic. Since both the sliding arm 200 and the damping member 400 are made of the POM, the POM can provide a stable buffer effect due to its high strength, high rigidity, high wear resistance, and a flexible movement property.

In some embodiments, the sliding arm 200 includes a sliding body 210 and a stop member 220. The sliding body includes the sliding groove 212. One end of the sliding groove 212 extends through the sliding body 210 so that it is convenient to make a mold. The stop member 220 is disposed at the end of the sliding groove 212 to block an end opening of the sliding groove 212, improving the strength of the sliding body 210. A stop ring is provided at the other end of the sliding groove 212. The stop ring forms the first damping portions 211. The outer diameter of the sliding member 300 is greater than the inner diameter of the stop ring and the sliding member 300 is capable of being abutted against the stop ring. The stop member 220 is connected to the sliding body 210, and the second limit portion 221 is provided on the stop member 220. When the sliding member 300 is retracted into the sliding groove 212, the sliding member 300 is abutted against the stop ring to be limited. In addition, the stop ring is made of the POM.

The sliding body 210 includes the sliding groove 212. The sliding member 300 is disposed in the sliding groove 212. The stop member 220 has a cylindrical structure and is sleeved on an end of the sliding body 210. An integrally formed stop plate is provided at an end portion of the stop member 220. At least part of the stop plate is located in the sliding groove 212. The stop plate is the second limit portion 221. A buffer portion protrudes on a side of the damping member 400 facing the second limit portion 221 for being abutted against the second limit portion 221. The stop member 220 may be made of metal. In a left and right direction, the buffer portion and a mounting hole are spaced apart. When the sliding member 300 is moved out of the sliding groove 212, the buffer portion can be abutted against the stop member 220. Thus, impact on the horizontal damping portion 423 is prevented and the stability of the vertical damping portions 424 is ensured, which is conducive to ensuring the damping feel.

A strip-shaped buffer block 430 protrudes outwards and is formed on the side of the damping member 400 facing the second limit portion 221 so that the buffer portion is formed. The buffer block 430 extends along a vertical direction. At least two buffer blocks 430 are provided. The two buffer blocks 430 are spaced apart along a direction perpendicular to the extension direction of each of the two buffer blocks 430. That is, the two buffer blocks 430 are spaced apart along a front and rear direction.

The extension direction of the sliding arm 200 is the left and right direction. The sliding arm 200 is bent downwards. The width direction of the sliding arm 200 is the front and rear direction.

A strip-shaped stop portion 222 extending towards the inside of the stop member 220 is formed on a sidewall of the stop member 220 through blanking. The outer sidewall of the sliding body 210 is provided with a stop slot 216 and a stop protrusion 217. The stop slot 216 and the stop protrusion 217 are spaced apart along the extension direction of the sliding groove 212. The stop portion 222 is insertable into the stop slot 216 and is capable of being abutted against a sidewall of the stop slot 216 facing away from the stop protrusion 217. The stop member 220 is abutted against the stop protrusion 217. In a mounting process, the stop member 220 needs to be sleeved on the sliding body 210. Then, the stop member 220 is pushed so that the stop portion 222 is turned outwards when the stop portion 222 is abutted against the sliding body 210. When the stop portion 222 moves to the stop slot 216, an end portion of the stop portion 222 enters the stop slot 216 under the action of the elastic force of the stop portion 222. In addition, an end portion of the stop member 220 is abutted against the stop protrusion 217 so that the stop member 220 and the sliding body 210 are axially limited. Furthermore, at least two stop slots 216 and at least two stop portions 222 are provided in a one-to-one correspondence. The stop portions 222 are spaced apart along the circumferential direction of the stop member 220 to limit the stop member 220 circumferentially. In addition, the stop plate is prevented from being in contact with the sidewalls at the opening of the sliding groove 212 to affect limit precision.

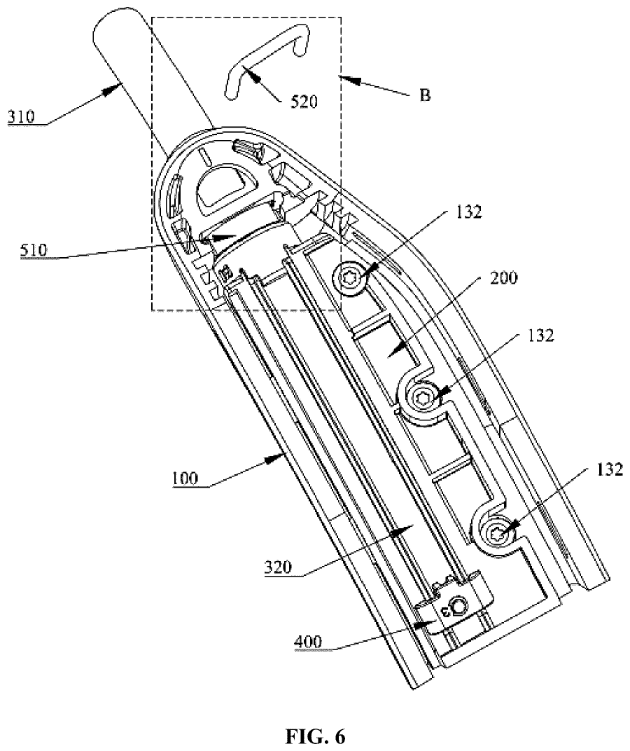

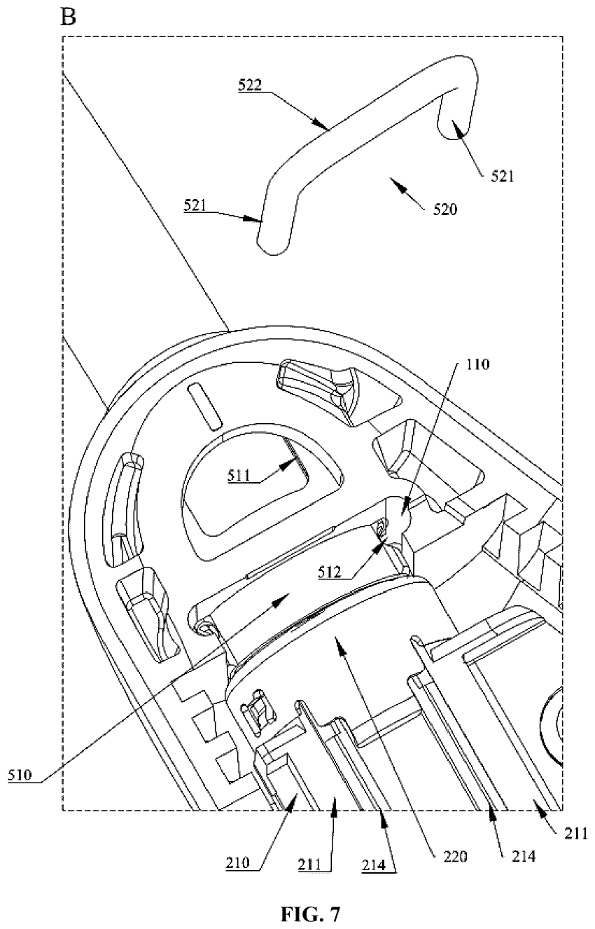

In conjunction with FIGS. 6 and 7, since the sliding member 300 has an elongated structure, the housing 100 needs to be fixed, and the sliding member 300 is held manually to be pulled outwards or pushed inwards during the use of the sliding member 300 so that the sliding member 300 moves relative to the housing 100. Since the sliding member 300 is operated manually, it is inevitable to apply a force unevenly. To prevent the force from affecting the abutment between the damping member 400 and the sliding member 200 to affect the damping feel therebetween, in some embodiments, the housing 100 has an accommodation cavity and a sliding channel communicating with the accommodation cavity. The damping mechanism further includes a guide assembly 500 having a guide slideway 511. The guide assembly 500 is disposed in the sliding channel. The sliding member 300 is inserted through in the guide slideway 511 and is slidable relative to the guide assembly 500 under the guide action of the guide slideway 511. At least part of the sliding member 300 connected to the damping member 400 is located in the accommodation cavity. With this configuration, the sliding member 300 is restricted by the guide assembly 500. Even if the direction in which the force is applied is not parallel to a sliding direction, forces other than a pushing or pulling force are prevented from being transmitted to the damping component 400. Thus, it is ensured that the pressure between the damping member 400 and the sliding arm 200 remains stable, thereby improving the stability of the damping feel.

To adapt to the structure of the headset, in some embodiments, the guide slideway 511 is arc-shaped. The sliding member 300 includes the sliding-fit portion 320 and the external sliding connection portion 310 that are connected to each other. The sliding-fit portion 320 is slidably disposed in the guide slideway 511 and is arc-shaped. The sliding-fit portion 320 and the sliding channel have the same radian. With this configuration, the entire damping mechanism can be placed at and fit snugly around the top of the user's head during use.

In some embodiments, the guide assembly 500 includes a guide member 510 with a cylindrical structure and a connector 520. The guide slideway 511 is provided in the guide member 510. The connector 520 is arranged to be capable of detachably connecting the guide member 510 to the housing 100. This configuration facilitates assembly and improves assembly efficiency. In addition, for different types of sliding members 300, only the guide member 510 needs to be replaced, and the connector 520 can be versatile, thereby reducing the cost of making the mold.

To facilitate connection and improve connection efficiency, in some embodiments, the guide member 510 is partially inserted in the sliding channel. A first engagement slot 512 is recessed from the outer sidewall of the part of the guide member 510 located outside the sliding channel. The housing 100 includes a second engagement slot 110. When the guide member 510 is mounted in the sliding channel, the first engagement slot 512 and the second engagement slot 110 enclose an engagement channel. The extension direction of the engagement channel is perpendicular to the extension direction of the sliding channel. The connector 520 includes a columnar engagement portion 521 insertable into the engagement channel. With the preceding configuration, the guide member 510 is restricted axially and can be prevented from rotating about the axis thereof.

In some embodiments, the guide member 510 includes two first engagement slots 512, and the housing 100 includes two second engagement slots 110 corresponding to the two first engagement slots 512 respectively to form two engagement channels. The two engagement channels are respectively provided on two sides of the axis of the guide member 510. The connector 520 includes two engagement portions 521 provided in parallel, and the two engagement portions 521 are correspondingly insertable into the two engagement channels. The two engagement portions 521 are connected through a connection rod 522, and the two engagement portions 521 and the connection rod 522 are U-shaped as a whole. In the mounting process, the connection rod 522 only needs to be held manually such that the two engagement portions 521 are inserted into the two engagement channels. When the engagement portions 521 are mounted in place, a gap is left between the connection rod 522 and the guide member 510 so that it is convenient to manually hold the connection rod 522.

In conjunction with FIGS. 3 to 5, to improve assembly convenience, in some embodiments, the damping mechanism further includes a fixedly connected member 230. One end of the fixedly connected member 230 is fixedly connected to the sliding member 300, and the other end of the fixedly connected member 230 is fixedly connected to the damping member 400. This configuration can further simplify the structure of the sliding member 300 and the structure of the damping member 400, thereby facilitating production and the assembly. A fixedly connected channel 231 is provided at an end of the fixedly connected member 230. The sliding member 300 is inserted through the fixedly connected channel 231 and is connected to the fixedly connected member 231 by screwing or bonding. In some embodiments, the sliding member 300 is connected to the fixedly connected member 231 by screwing and bonding. For example, the sliding member 300 has a hollow structure, and a sidewall of the sliding member 300 is provided with a dispensing hole 322 that extends through to the fixedly connected channel 231. After the sliding member 300 is inserted through the fixedly connected channel 231, glue is dispensed in the dispensing hole 322 so that the glue smoothly enters the gap between the sliding member 300 and the fixedly connected member 230. The outer diameter of the fixedly connected member 230 is greater than the inner diameter of the stop ring and the fixedly connected member 230 may be abutted against the stop ring. The fixedly connected member 230 is abutted against the stop ring to be limited when the sliding member 300 is retracted into the sliding groove 212.

The sliding arm 200 includes the sliding groove 212. The sliding member 300 has a circular cross section and is slidably disposed in the sliding groove 212. A sliding bump 233 is provided at the lower end of the fixedly connected member 230. A sliding rail 218 is recessed from the inner wall of the sliding groove 212. The sliding bump 233 is slidably disposed in the sliding rail 218 along the sliding direction of the sliding member 300. In the process where the sliding member 300 slides relative to the housing 100, the fixedly connected member 230 is driven to slide such that the sliding bump 233 slides in the sliding rail 218 and is prevented from shifting. Thus, the sliding trajectory of the sliding member 300 is defined, thereby preventing a shifting sliding member 300 from causing a position shift between the damping member 400 and the sliding arm 200. In this manner, the damping effect is ensured. The sliding bump 233 includes an accommodation slot 2331, which facilitates the injection molding of the sliding bump 233 and reduces the probability of collapse. The bottom of the accommodation slot 2331 is provided with a threaded hole that extends through to the fixedly connected channel 231. The extension direction of the threaded hole is perpendicular to the extension direction of the fixedly connected channel 231. A locking screw is threadedly connected to the threaded hole and at least partially inserted into a stop hole of the sliding member 300. The locking screw may be concealed in the accommodation slot 2331 and is prevented from being scratched.

To prevent the sliding member 300 and the fixedly connected member 230 from rotating relative to each other, a first anti-rotation plane 321 is provided at the position where the fixedly connected member 230 is sleeved on and fitted with the sliding member 300, and a second anti-rotation plane 234 is provided on the inner wall of the fixedly connected channel 231. The first anti-rotation plane 321 and the second anti-rotation plane 234 are parallel to and fit snugly with each other. In the embodiment of the present disclosure, the top of the fixedly connected member 230 is provided with limit surfaces 237. The limit surfaces 237 are abutted against the bottom surfaces of the necking portions 213. That is, the necking portions 213 are clamped between the fixedly connected member 230 and the damping member 400. The fixedly connected member 230 is made of metal, and the frictional force between the fixedly connected member 230 and the necking portions 213 is negligible. Of course, a solid lubricant may be applied between the fixedly connected member 230 and the necking portion 213.

To improve the efficiency with which the fixedly connected member 230 and the damping member 400 are assembled, in some embodiments, a fixing rod 235 protrudes at the other end of the fixedly connected member 230, and the damping member 400 includes a mounting hole. The fixing rod 235 is inserted through the mounting hole. An end portion of the fixing rod 235 is provided with an engagement groove 236, and a circlip 240 is engaged in the engagement groove 236 to be pressed against the damping member 400.

Along the extension direction of the fixing rod 235, the length of the engagement groove 236 is greater than twice the thickness of the circlip 240. When the damping feel becomes weaker, it is only necessary to add one circlip 240 or replace the circlip 240 with a circlip 240 of a greater thickness in a maintenance process.

To prevent the damping member 400 from rotating about the axis of the fixing rod 235, in some embodiments, one of the fixedly connected member 230 and the damping member 400 includes a positioning slot 238 and the other includes a positioning protrusion. The positioning protrusion and the fixing rod 235 are spaced apart along the sliding direction of the sliding member 300. When the fixing rod 235 is inserted through the mounting hole, the positioning protrusion is inserted into the positioning slot 238. The positioning slot 238 is provided on the fixedly connected member 230, and the damping member 400 includes the positioning protrusion. The positioning slot 238 is located on a side of the fixing rod 235. A fixing boss 232 is provided at the upper end of the fixedly connected member 230. The fixing rod 235 is provided on the top surface of the fixing boss 232. Part of the top surface of the fixing boss 232 is recessed to form the positioning slot 238.

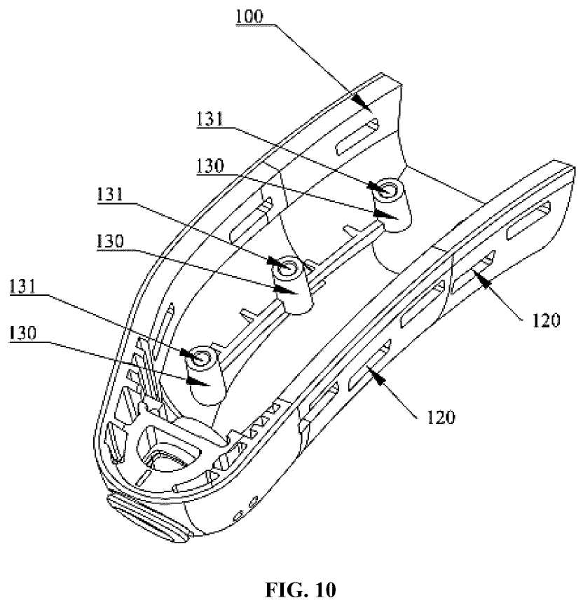

In conjunction with FIGS. 9 and 10, in some embodiments, the sliding arm 200 is detachably connected to the housing 100. An insertion protrusion 2191 is disposed on one side of the sliding arm 200. The housing 100 includes an insertion slot 120. The insertion protrusion 2191 is inserted into the insertion slot 120. A fixing hole 2192 is provided on the other side of the sliding arm 200. The housing 100 includes a fixing column 130, and the fixing column 130 includes a fixing screw hole 131. A fastener 132 passes through the fixing hole 2192 and may be threadedly connected in the fixing screw hole 131. Two insertion protrusions 2191 are provided and spaced apart along the left and right direction. Two insertion slots 120 are provided in one-to-one correspondence with the two insertion protrusions 2191. Three fixing holes 2192 are provided and spaced apart along the left and right direction. Three fixing columns 130 are provided in one-to-one correspondence with the three fixing holes 2192. Along the left and right direction, each of the two insertion slots 120 is located in the gap between respective two of the three fixing holes 2192, thereby applying a more balanced force.

The embodiment of the present disclosure further provides a headset including the damping mechanism for the headset in any one of the preceding embodiments.

Apparently, the preceding embodiments of the present disclosure are only illustrative examples of the present disclosure and are not intended to limit embodiments of the present disclosure. Those of ordinary skill in the art may make changes or variations in other different forms based on the preceding description. All embodiments do not need to be and cannot be exhausted herein. Any modifications, equivalent substitutions, and improvements made within the spirit and principle of the present disclosure fall within the scope of the claims of the present disclosure.

What is claimed is:

1. A headset comprising a damping mechanism, wherein the damping mechanism comprises:
a housing, wherein at least part of the housing is arc-shaped;
a sliding arm, wherein the sliding arm is arc-shaped and disposed in the housing, and the sliding arm has elongated first damping portions;
a sliding member slidably connected to the housing; and
a damping member, wherein the damping member is connected to the sliding member and is capable of moving relative to the sliding member, the damping member has second damping portions capable of being press-fitted with the first damping portions to generate frictional forces between the second damping portions and the first damping portions during reciprocating movement of the sliding member relative to the housing.

2. The headset comprising the damping mechanism according to claim 1, wherein the sliding arm comprises a sliding groove, the sliding member comprises an external sliding connection portion and a sliding-fit portion, the sliding-fit portion is arc-shaped and has a radian that is consistent with a radian of the sliding arm, and the sliding-fit portion is disposed in the sliding groove and is fixedly connected to the damping member.

3. The headset comprising the damping mechanism according to claim 2, wherein two opposite sidewalls at an opening of the sliding groove protrude towards each other to form necking portions, parts of top surfaces of the necking portion form the first damping portions, the damping member comprises a mounting portion and a friction portion that are connected to each other, the mounting portion is mounted on an upper side of the sliding member and partially extends out of the sliding groove, the friction portion is located on an outer side of the sliding groove and an extension direction of the friction portion is perpendicular to an extension direction of the sliding groove, a length of the friction portion is greater than a width of the sliding groove, a bottom surface of the friction portion form the two second damping portions, the two second damping portions are pressed against the first damping portions, and the sliding member is abutted against a bottom surface of the necking portion.

4. The headset comprising the damping mechanism according to claim 2, wherein two sliding protrusions that are strip-shaped and extend in a direction parallel to an extension direction of the sliding groove are provided on a top of the sliding arm, the two sliding protrusions are respectively provided on two sides of the sliding groove, the damping member comprises two sliding slots, and the two sliding slots correspond to and are in a sliding fit with the two sliding protrusions.

5. The headset comprising the damping mechanism according to claim 1, wherein a first limit portion and a second limit portion are spaced apart on the sliding arm, wherein the sliding member is stopped by the damping member and is abutted against the first limit portion in a process where the sliding member slides along the sliding arm, or the sliding member is stopped by the damping member and is abutted against the second limit portion in the process where the sliding member slides along the sliding arm.

6. The headset comprising the damping mechanism according to claim 5, wherein the sliding arm comprises a sliding body and a stop member, wherein the sliding body comprises a sliding groove and a stop ring that is provided at an end portion of the sliding groove, the stop ring forms the first damping portion, an outer diameter of the sliding member is greater than an inner diameter of the stop ring and the sliding member is capable of being abutted against the stop ring, the stop member is connected to the sliding body, and part of the stop member forms the second limit portion.

7. The headset comprising the damping mechanism according to claim 6, wherein the sliding member is disposed in the sliding groove, the stop member has a cylindrical structure and is sleeved on an end of the sliding body, an integrally formed stop plate is provided at an end portion of the stop member, at least part of the stop plate is located in the sliding groove, the stop plate is the second limit portion, and a buffer portion protrudes on a side of the damping member facing the second limit portion for being abutted against the second limit portion.

8. The headset comprising the damping mechanism according to claim 7, wherein a strip-shaped stop portion extending towards an inside of the stop member is formed on a sidewall of the stop member through blanking, and an outer sidewall of the sliding body is provided with a stop slot and a stop protrusion, the stop slot and the stop protrusion are spaced apart along an extension direction of the sliding groove, the stop portion is insertable into the stop slot and is capable of being abutted against a sidewall of the stop slot facing away from the stop protrusion, and the stop member is abutted against the stop protrusion.

9. The headset comprising the damping mechanism according to claim 1, the damping mechanism further comprising a fixedly connected member, wherein one end of the fixedly connected member is fixedly connected to the sliding member and another end of the fixedly connected member is fixedly connected to the damping member.

10. The headset comprising the damping mechanism according to claim 9, wherein a fixedly connected channel is provided at an end of the fixedly connected member, and the sliding member is inserted through the fixedly connected channel and is connected to the fixedly connected member by at least one of screwing or bonding.

11. The headset comprising the damping mechanism according to claim 10, wherein the headset comprising the damping mechanism satisfies at least one of the following:
the sliding arm comprises a sliding groove, the sliding member has a circular cross section and is slidably disposed in the sliding groove, a sliding bump is provided at a lower end of the fixedly connected member, a sliding rail is recessed from an inner wall of the sliding groove, and the sliding bump is slidably disposed in the sliding rail along a sliding direction of the sliding member; or
a first anti-rotation plane is provided at a position where the fixedly connected member is sleeved on and fitted with the sliding member, a second anti-rotation plane is provided on an inner wall of the fixedly connected channel, and the first anti-rotation plane and the second anti-rotation plane are parallel to and fit snugly with each other.

12. The headset comprising the damping mechanism according to claim 9, wherein a fixing rod protrudes at the other end of the fixedly connected member, the damping member is provided with a mounting hole, the fixing rod is inserted through the mounting hole, and an end portion of the fixing rod is provided with an engagement groove, and a circlip is engaged in the engagement groove to be pressed against the damping member.

13. The headset comprising the damping mechanism according to claim 12, wherein one of the fixedly connected member and the damping member comprises a positioning slot and another one of the fixedly connected member and the damping member comprises a positioning protrusion, the positioning protrusion and the fixing rod are spaced apart along a sliding direction of the sliding member, and in response to the fixing rod being inserted through the mounting hole, the positioning protrusion is inserted into the positioning slot.

14. The headset comprising the damping mechanism according to claim 1, wherein the housing has an accommodation cavity and a sliding channel communicating with the accommodation cavity, the damping mechanism further comprises a guide assembly having a guide slideway, the guide assembly is disposed in the sliding channel, the sliding member is inserted through the guide slideway and is slidable relative to the guide assembly under a guide action of the guide slideway, and at least part of the sliding member connected to the damping member is located in the accommodation cavity.

15. The headset comprising the damping mechanism according to claim 14, wherein the guide slideway is arc-shaped, the sliding member comprises a sliding-fit portion and an external sliding connection portion that are connected to each other, the sliding-fit portion is slidably disposed in the guide slideway and is arc-shaped, and the sliding-fit portion and the sliding channel have a same radian.

16. The headset comprising the damping mechanism according to claim 14, wherein the guide assembly comprises a guide member with a cylindrical structure and a connector, the guide slideway is provided in the guide member, and the connector is arranged to be capable of detachably connecting the guide member to the housing.

17. The headset comprising the damping mechanism according to claim 16, wherein the guide member is partially inserted in the sliding channel, the guide member comprises a first engagement slot, the housing comprises a second engagement slot, in response to the guide member being mounted in the sliding channel, the first engagement slot and the second engagement slot enclose an engagement channel, an extension direction of the engagement channel is perpendicular to an extension direction of the sliding channel, and the connector comprises a columnar engagement portion and is insertable into the engagement channel.

18. The headset comprising the damping mechanism according to claim 17, wherein the guide member comprises two first engagement slots, the housing comprises two second engagement slots corresponding to the two first engagement slots to form two engagement channels, the two engagement channels are respectively provided on two sides of an axis of the guide member, the connector comprises two engagement portions provided in parallel, and the two engagement portions are correspondingly insertable into the two engagement channels.

19. The headset comprising the damping mechanism according to claim 1, wherein a material of the sliding arm and a material of the damping member are each polyoxymethylene, and the material of the sliding arm and a material of the housing are different from each other.

20. The headset comprising the damping mechanism according to claim 2, wherein a material of the sliding arm and a material of the damping member are each polyoxymethylene, and the material of the sliding arm and a material of the housing are different from each other.
